(19) United States
(12) Patent Application Publication
(10) Pub. No.: US 2026/0140736 A1
(43) Pub. Date: May 21, 2026

(54) Dynamic Feature Management and Version Control in Distributed Software Applications

(71) Applicant: SAP SE, Walldorf (DE)

(72) Inventors: Ajit Dash, Cupertino, CA (US); Anil Samudrala, Newark, CA (US); Kevin Wright, San Jose, CA (US); Wai-Ming Ng, Sunnyvale, CA (US); Aravind Gadagottu, San Jose, CA (US)

(73) Assignee: SAP SE, Walldorf (DE)

(21) Appl. No.: 18/952,892

(22) Filed: Nov. 19, 2024

(51) Int. Cl. G06F 8/71; G06F 8/65

(52) U.S. Cl. CPC G06F 8/71; G06F 8/65

(57) ABSTRACT

The present disclosure provides techniques and solutions for managing feature activation across different software versions for clients in a distributed environment. Upon receiving a request to activate a feature of a software application, a flag is set indicating the feature's availability. For clients operating with an older version of the software, the feature identifier is different than an identifier of the activated feature, which temporarily prevents feature activation for such clients. When a client's software version is updated to a compatible version, the identifier associated with the client is replaced with an identifier enabling the feature. The system maintains version-specific content, including data schemas and stored procedures, for both old and new software versions during transitions. Additionally, external client requests are routed through appropriate interfaces based on the client's software version, supporting seamless feature updates and continuity in operations across different versions, such as within a multi-tenant computing environment.

### FIELD

The present disclosure relates to systems and methods for managing feature activations when multiple clients of a computing system may be operating in different software version states.

### BACKGROUND

Particularly as software applications transition to cloud-based operation, it is common for a particular single instance of a software application to handle operations for a plurality of discrete clients, such as tenants of a multi-tenant application of a computing cluster. For example, multiple tenants may use a common application instance for performing data replication. However, issues can arise when performing software updates in these environments.

For example, typically all tenants need to be configured to work with the same software version. Issues can arise if some tenants have been updated to work with an updated common application instance and some have not. For these reasons, it is common to take an entire computing cluster offline so that the common application instance and all of the tenants can be updated, and then the cluster is brough back online. This can negatively impact end users, as there can be significant system downtime. Although processing can be switched to another cluster and then transferred back to the original cluster after update, this can involve significant computing resources to provision the new cluster, and to make sure communications for the original cluster are successfully routed to the new cluster.

Typical practices can also result in significant delays in introducing new features. Specifically, new features are often bundled into major releases, which are infrequent due to having multiple updates combined in a single update, rather than releasing new updates as they are available, and the need to coordinate updates across all tenants in a cluster. This approach is driven by the typical requirement that all tenants must be updated simultaneously, as well as the preference to minimize frequent or extended downtime. As a result, organizations face delays in deploying important features, stifling innovation and responsiveness to user needs. Moreover, this bundling of features into major releases increases the complexity of updates, often requiring substantial pre-release testing and coordination. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for managing feature activation across different software versions for clients in a distributed environment. Upon receiving a request to activate a feature of a software application, a flag is set indicating the feature's availability. For clients operating with an older version of the software, the feature identifier is different than an identifier of the activated feature, which temporarily prevents feature activation for such clients. When a client's software version is updated to a compatible version, the identifier associated with the client is replaced with an identifier enabling the feature. The system maintains version-specific content, including data schemas and stored procedures, for both old and new software versions during transitions. Additionally, external client requests are routed through appropriate interfaces based on the client's software version, supporting seamless feature updates and continuity in operations across different versions, such as within a multi-tenant computing environment.

In one aspect, the present disclosure provides a process of activating a feature for use by a client. A request to activate code representing a feature of a software application is received, the feature having a first value for an identifier that the software application uses to call functionality of the feature. In response to the request, a flag for the feature is set to a value that indicates that the feature is activated for use by clients.

For a first client, the first client is associated with a second value of the identifier of the feature that differs from the first value of the identifier of the feature. A version of first software installed for the first client is tracked. It is determined at that the version of the first software installed for the first client does not support the feature. At a second time, it is determined that the version of the first software installed for the first client has been updated to a version that does support the feature. At the second time which is after the first time, in response to determining that the version of the first software installed for the first client does not support the feature, the second value of the identifier of the feature is replaced with the first value of the identifier of the feature as associated with the first client, thereby enabling functionality of the feature for the first client.

The present disclosure also includes computing systems and tangible, non-transitory computer readable storage media configure to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram of a computing environment in which disclosed techniques can be implemented.

FIG. 2 is a diagram depicting how feature activation can be granularly controlled for tenants using a combination of feature toggles and feature naming.

FIGS. 3A and 3B are example tables that include feature toggle and version states for particular tenants, along with the feature name currently used by a given tenant.

FIG. 4 is a flowchart of a process of generating and executing task requests during a tenant update process.

FIG. 5 is a flowchart of an example process of activating a feature for use by a client.

FIG. 6 is a diagram of an example computing system in which some described embodiments can be implemented.

FIG. 7 is an example cloud computing environment that can be used in conjunction with the technologies described herein.

### DETAILED DESCRIPTION

### Example—Overview

Particularly as software applications transition to cloud-based operation, it is common for a particular instance of a software application to handle operations for a plurality of discrete tenants. For example, multiple tenants may use a common application instance for performing data replication.

Particularly as software applications transition to cloud-based operation, it is common for a particular single instance of a software application to handle operations for a plurality of discrete clients, such as tenants of a multi-tenant application of a computing cluster. For example, multiple tenants may use a common application instance for performing data replication. However, issues can arise when performing software updates in these environments.

For example, typically all tenants need to be configured to work with the same software version. Issues can arise if some tenants have been updated to work with an updated common application instance and some have not. For these reasons, it is common to take an entire computing cluster offline so that the common application instance and all of the tenants can be updated, and then the cluster is brough back online. This can negatively impact end users, as there can be significant system downtime. Although processing can be switched to another cluster and then transferred back to the original cluster after update, this can involve significant computing resources to provision the new cluster, and to make sure communications for the original cluster are successfully routed to the new cluster.

Typical practices can also result in significant delays in introducing new features. Specifically, new features are often bundled into major releases, which are infrequent due to having multiple updates combined in a single update, rather than releasing new updates as they are available, and the need to coordinate updates across all tenants in a cluster. This approach is driven by the typical requirement that all tenants must be updated simultaneously, as well as the preference to minimize frequent or extended downtime. As a result, organizations face delays in deploying important features, stifling innovation and responsiveness to user needs. Moreover, this bundling of features into major releases increases the complexity of updates, often requiring substantial pre-release testing and coordination. Accordingly, room for improvement exists.

The present disclosure provides techniques and solutions that facilitate more frequent software updates while allowing a cluster of tenants (or, more generally, clients of an application instance) to remain operational even if the tenants are running different software versions. This approach addresses issues that arise when not all tenants can be updated simultaneously, such as when some tenants encounter update failures or are scheduled for staggered deployments. Using feature identifiers and tenant-specific repositories, tenants can progress through updates according to their specific software versions, with the application instance accommodating both updated and legacy versions concurrently.

In one aspect, features of a software application can be updated independently of the core software lifecycle. For example, a first release of the software application may include only a stub or partial implementation of a feature. Rather than waiting for a full subsequent software release to complete or activate the feature, the first release can deploy the feature stub, using a state indicator to deactivate it. Once the full feature implementation is installed, this indicator can be toggled to an active state. This approach decouples feature installation and activation from the main application's lifecycle, allowing more flexibility in feature rollouts. By storing version-specific identifiers in tenant repositories, features can be activated for individual tenants as soon as their software versions support them, without requiring a complete cluster update.

When a feature toggle is activated at the cluster level, it may still be desirable to selectively apply the toggle to tenants that have compatible software versions. For instance, in a large cluster, updating all tenants at once may not be feasible, and some updates may fail for certain tenants. In this context, tenants may run software that coordinates with a cluster-level application, such as a replication application serving all tenants, while each tenant also has replication software that interacts with the shared replication application. Using tenant-specific repositories, feature toggling can be managed independently per tenant, allowing backward compatibility with tenants that remain on earlier software versions.

As will be explained in further detail, cluster applications can include a task manager that schedules tasks to a task executor framework, which is a cluster application responsible for task distribution across the computing environment. Tenants implement task executors that execute assigned tasks as tenant applications. Each task manager and tenant-specific task executor accesses its associated tenant repository to retrieve relevant configurations and feature identifiers, processing tasks according to the version-specific logic and feature settings appropriate for each tenant.

This framework allows a “green” (updated) version of the cluster-level task manager and task executor framework to interact with “blue” (older) versions of tenant-specific task executors and their task execution frameworks. Tasks initiated under the older version of the software can thus proceed without interruption, preserving backward compatibility. Cluster applications remain updated, but tenants that have not yet transitioned to the green version continue operating with their blue software versions. This architecture enables continuous task processing across tenants, regardless of their individual software version, minimizing downtime as updates are applied. Tenant repositories store both blue or green configurations, as appropriate, facilitating smooth transitions between versions during update cycles.

In one implementation, feature updates involve associating features with a toggle state and specific identifier, which may be stored as a variable, database table entry, or other data structure. When the feature is invoked, programmatic logic checks for activation based on the toggle state. If activated, the feature's functionality becomes available to that tenant. Version-specific feature names stored in tenant repositories prevent premature activation of the feature for tenants that have not yet updated, limiting access to the feature's functionality to only those tenants whose software versions support it.

In cases where the cluster-level toggle is set to the on state, disclosed techniques provide compatibility across different tenant versions by allowing the green cluster applications to handle tasks initiated under blue tenant frameworks. Typically, toggling the feature on would activate it for all tenants, but here, feature identifiers allow selective activation, where each tenant's access to the feature is based on its version. In this way, a feature remains inactive for tenants running older software versions until their code is updated, allowing newly updated tenants to access the feature without requiring all tenants to reach the updated state first. Tenant repositories leverage version-specific identifiers to manage feature activation, limiting the active feature state to only the relevant tenants.

Initially, tenants may receive a “placeholder” feature name (e.g., feature_1_inactive) that prevents premature execution of the feature's functionality. When programmatic calls to feature_1 are made, the absence of this identifier in unupdated tenants blocks the feature's execution. Upon updating to the required version and completing the feature implementation, the feature name is modified to the actual name (e.g., feature_1) for that tenant. This approach provides fine-grained control, allowing tenants to remain at different update states within a cluster, without necessitating a full cluster or tenant shutdown during updates. Feature identifiers are distributed as part of the deployed update content for each tenant, activating the feature once the tenant's version supports it.

### Example—Example Computer Environment with Computer Cluster in Two Software States

A computing cluster in a cloud environment includes interconnected physical or virtual nodes working together, providing a distributed framework capable of managing large-scale applications and services. These clusters dynamically allocate computational tasks across nodes, delivering scalability, high availability, and fault tolerance. Typically, a cluster includes a control plane that orchestrates overall operations and worker nodes where application workloads are executed. Each node contributes processing power, memory, and storage, forming a unified resource pool.

Cluster resource orchestration is generally managed by platforms like Kubernetes, which automates the deployment, scaling, and operation of containerized applications. The following discussion explains general features of Kubernetes and similar software, incorporating details relevant to disclosed innovations. These innovations specifically address challenges in updating applications across multi-tenant clusters.

Kubernetes helps maintain a desired state of the cluster by keeping the correct number of application instances (or “pods”), monitoring their health, and automatically restarting or relocating them if failures occur. Kubernetes operates through several core control plane components, including an API server, controller manager, scheduler, and etcd, a distributed key-value store. For tenant-specific versioning, the control plane uses Kubernetes orchestration to operate and monitor independent repositories for each tenant, each with configurations and feature toggles matching their respective version states.

The Kubernetes API server provides an interface between the control plane and external commands. It allows users or systems to query the cluster's state or issue commands to create, delete, or modify resources. Interactions—whether through command-line tools, graphical interfaces, or automated systems—are processed by the API server. The etcd service stores cluster configuration data, helping the cluster match its current state to a designated configuration. In multi-repository configurations, the API server and etcd manage versioned configuration data across multiple tenant repositories, supporting updates and specific feature controls per tenant without disrupting operations.

The Kubernetes scheduler assigns pods, which are the smallest deployable units in Kubernetes, to specific worker nodes based on resource availability and constraints like CPU or memory. When a pod is created or updated, the scheduler selects an appropriate node to handle the workload. The Kubelet, an agent on each worker node, manages the pod's lifecycle, allowing containers to run as expected while reporting any failures to the control plane. Disclosed innovations incorporate version-specific data, such as feature toggles and configuration settings, deployed to pods in tenant-specific applications. This data is provided through tenant repositories during updates, allowing each tenant to operate with the proper configurations without needing real-time queries from a central repository.

The controller manager oversees routine tasks, such as maintaining the desired number of pod replicas or scaling services up or down in response to demand. It also performs system-level operations that improve fault tolerance by distributing pods across nodes and managing rolling updates to reduce downtime.

Applications in Kubernetes are typically packaged and deployed as containers using a container runtime like Docker. Docker packages the application code and its dependencies into a portable unit, allowing consistent operation across various environments. Containers run in isolated environments, which enables multiple containers to coexist on the same node without interference while maintaining resource control and security. For tenant-specific applications, disclosed innovations provide isolated containers or pods for each tenant, where each application instance accesses configurations and feature toggles specific to its assigned version. This approach supports independent feature access and tenant-specific versioning across the multi-tenant cluster.

Docker containers are based on Docker images, read-only templates containing the application code and dependencies. These images are built from Dockerfiles, which define the configuration and environment setup. Once built, these images are stored in a container registry and pulled as needed to deploy new pods, simplifying application dependency management. In contexts that leverage tenant-specific applications, images may include feature identifiers unique to each tenant, allowing or restricting feature use based on the tenant's version.

Kubernetes manages containers via pods, which typically represent a single instance of an application or service. A pod may also contain multiple containers that closely communicate and share resources, such as a web server and a logging or caching sidecar. Pods within a node share networking and storage, each with a unique IP address in the cluster that facilitates service communication.

In multi-tenant cloud environments, each tenant typically operates its own software instance or processes within a shared cluster. There are several strategies to isolate tenant-specific software, even as a shared application handles overall orchestration and task management:
Tenant-Specific Containers: Each tenant may have its own containers, which can run within the same pod as the shared application or in separate pods. These containers manage tenant-specific processes, such as data replication, independently.
Tenant-Specific Virtual Machines (VMs): Each tenant can operate within its own VM, managed alongside Kubernetes. This setup allows tenant-specific software to run and update separately from other tenants and the shared cluster application, with Kubernetes managing these VMs within a broader orchestration framework.
Namespaces and Resource Quotas: Kubernetes can isolate tenant-specific processes using namespaces, each acting as a contained environment for tenant resources. Resource quotas restrict resource usage per tenant, so shared resources are not monopolized.
Custom Resource Definitions (CRDs): Tenants can have Custom Resource Definitions that define their software version, configuration, and resource limits. These CRDs allow Kubernetes to manage tenant-specific software instances and handle updates independently.

These tenant-specific environments support updates and version transitions to occur independently for each tenant without impacting shared cluster applications. For instance, in data replication, the central replication engine might operate at the cluster level, while tenant-specific replication logic runs within its container or VM. By managing version-specific feature identifiers and data configurations for each tenant, disclosed innovations allow tenants to interact with the central application while maintaining compatibility between tenant-specific and shared software.

Kubernetes can employ horizontal scaling, where additional pod replicas are created to handle increased load. This scaling is managed by monitoring application performance metrics, such as CPU or memory usage, and adjusting the number of replicas as needed. Vertical scaling, which increases resources for existing pods, is also possible, though horizontal scaling often provides more efficient handling of dynamic cloud workloads. In multi-tenant scenarios, scaling may be implemented for each tenant's application instance to manage individual tenant load increases without impacting other tenants.

Kubernetes manages networking and service discovery for containers, providing stable, long-lived endpoints even as pods scale or relocate. Kubernetes services facilitate load balancing across pods, distributing traffic to maintain high performance and availability. In multi-tenant environments with tenant-specific updates, a router directs traffic to the correct versioned endpoints, enabling both blue and green versions to operate concurrently as tenants transition to updated software.

To account for the temporary nature of containers, Kubernetes provides persistent volumes that can be mounted into pods, allowing data to persist across pod lifecycles. These volumes can be backed by cloud storage, local disks, or network-attached storage systems. Persistent volumes for tenants store configuration states and data relevant to their software versions, maintaining consistency throughout updates.

Kubernetes supports deployment strategies like rolling updates and blue-green deployments. Rolling updates gradually replace old application versions with new ones, minimizing disruption. In blue-green deployments, two versions of the application (e.g., blue and green) run simultaneously, with traffic shifting from blue to green once validated, facilitating smooth, low-downtime transitions. For tenant-specific updates, disclosed techniques use content deployment with feature identifiers that activate in the green deployment. Blue-green deployments in multi-tenant environments allow certain tenants to update to green while others remain on blue, each interacting with the shared cluster application through their versioned software. This deployment method facilitates cluster-wide and tenant-specific updates, allowing seamless version transitions and continued operation across versions.

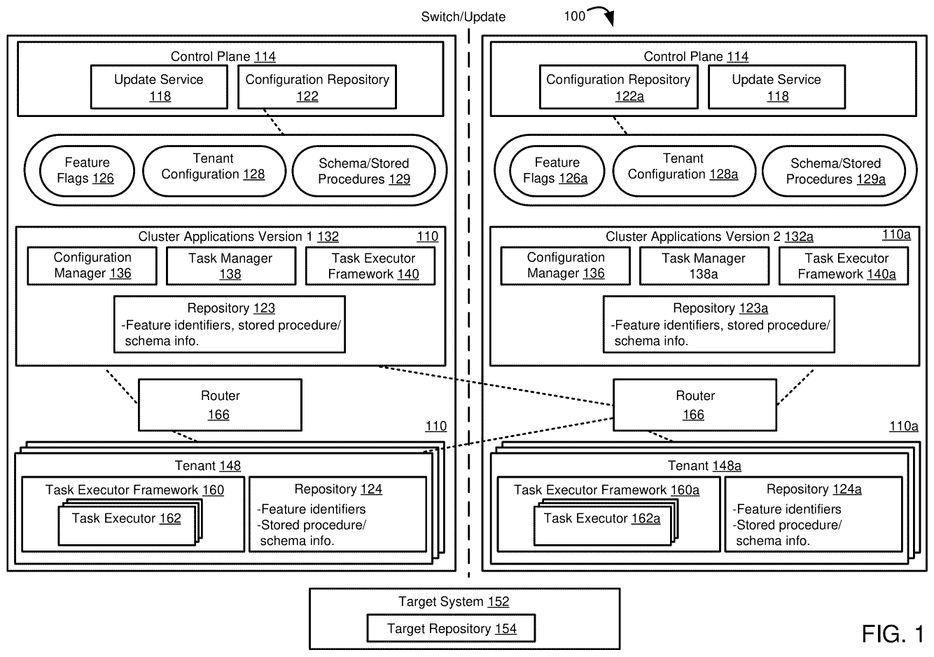

FIG. 1 provides a diagram of a computing environment 100 in which disclosed techniques can be implemented. A computing cluster 110 serves as the core infrastructure for managing applications and services across multiple tenants in the cloud environment. The computing cluster 110 includes a control plane 114 that functions as the central layer responsible for deploying, scaling, and managing the lifecycle of applications. It allocates resources and manages deployment of applications across worker nodes.

The control plane 114 includes an update service 118, which oversees the update process across the computing cluster 110. The update service 118 can introduce new application versions in a way that allows different versions of the software to coexist. The update service 118 manages the timing and process of these updates to minimize downtime, ensuring tenants remain operational, even when not all are updated simultaneously.

The control plane 114 can include, or can access, a configuration repository 122, which stores configuration data, application binaries, and feature flags necessary for deploying and managing updates. The update service 118 accesses this repository to provide the appropriate application data for version transitions. Additionally, the configuration repository 122 stores data needed to manage updates and provides this content to cluster application repositories 123, 123a and tenant repositories 124, 124a during the update process. These repositories support runtime operations for the cluster applications and tenants, operating independently of the configuration repository after each update. This provides consistency and reliable version management across the computing environment 100.

A first version of application feature flags 126, stored in the configuration repository 122, acts as a control mechanism that allows functionalities to be toggled on or off and can be used in conjunction with a renaming technique, described below, to further limit activation based on the tenant's software version. Centralizing feature flags 126 in the configuration repository 122 provides the control plane 114 with access to feature availability information during updates or tenant-specific transitions.

These feature flags 126 also facilitate more rapid deployment of features. A feature that is planned for future introduction can be included in a major application update, but initially toggled off. The feature may only be associated with a stub or partial implementation. When the feature is ready to be activated, new feature code can be deployed via an update, and the presence of the feature flag in the prior major software release allows that version of the software to support the updated feature by simply toggling the feature to the activated state.

Each feature flag 126 corresponds to a specific software feature, providing fine-grained control over activation. If a tenant's software version is incompatible with a feature, the flag remains inactive. During updates, the update service 118 interacts with the configuration repository 122 to retrieve and modify feature flags, updating them as tenants transition from the an old, or “blue” version of code a new, or a new, or “green” version of the code. Once an update is initiated, a green version of the repository 122 can be provided, version 122a.

Feature flags 126 allow partial feature implementations to exist without activation, so that a feature can remain inactive until fully tested or implemented. Once a tenant is updated, the relevant feature flag can be toggled, activating the feature. This decouples feature deployment from the update lifecycle, enabling faster updates while ensuring features are activated only when ready.

By storing feature flags 126 in the configuration repository 122, the control plane 114 can efficiently manage feature rollouts across tenants. A feature flag can be toggled on at the cluster level for all tenants when the feature code is deployed, regardless of the tenants' software version. Cluster application repositories 123, 123a store feature configurations specific to cluster applications, while tenant repositories 124, 124a enable tenant-level control over feature activation for their appropriate tenant version. The repositories 123, 124 receive updated configurations and feature flag data from the configuration repository 122 during the update process, rather than directly reading from it during runtime. In some implementations, instead of a literal rename operation, updated content is deployed with revised feature identifiers or names that indicate active status. This approach uses version-specific naming to control access, where tenants on older (blue) versions cannot utilize certain features, while tenants on updated (green) versions receive feature identifiers matching the “active” feature state, allowing them access.

The configuration repository 122 can store tenant version and feature name information as part of tenant configuration data 128, which assists in tracking each tenant's software version. Tenant-specific configuration data, including stored procedures and schema definitions from the configuration repository 122 or 122a, may be directly stored in the tenant repositories 124, 124a during updates. However, in some cases, feature flag state, name, and related configurations are not stored in tenant repositories 124a. Rather, this information is available to tenants 148a through the repository 123a, which in turn the repository 123a obtains this information from the repository 122a. This approach allows feature availability to be controlled dynamically and independently for each tenant, preventing access to incompatible features by maintaining configurations aligned with the tenant's current software version. Features thus remain inactive until a tenant is updated, at which point the updated configurations include identifiers matching the active feature name.

The tenant version and feature name information in the tenant configuration 128 is leveraged by the update service 118 to enable or disable features as appropriate for each tenant. When a tenant is updated, the repository 122 is updated (to 122a) to reflect the new version and its corresponding feature names. As well be further described, in a particular embodiment, a feature flag is togged on for all tenants when feature code is updated by the update service 118. Tenant name and version information in the tenant configuration 118 can be used to control at a more granular level when a feature will be active for a given tenant, despite a feature toggle being set to ON. This additional activation control mechanism helps ensure that tenants on different software versions can coexist without disrupting system operations. For instance, a tenant running an older version may have a feature name like feature_1_inactive, ensuring it remains deactivated even when the feature is toggled on, while tenants running the latest version might have feature_1 fully activated, and thus have a name of the feature that matches the “actual” feature name.

The source repositories 122, 122a, along with the cluster application repositories 123, 123a and tenant repositories 124, 124b, store schema definitions and stored procedures 129, 129a, which are used by the system cluster applications 132 and tenants 148 for various operations, such as data access, replication, and task execution. These schemas and stored procedures define how data is structured, accessed, and manipulated by both the cluster-level applications and the tenant-specific software. Tenants 148 use these schemas and stored procedures 129, 129a to carry out their tasks, such as running data queries, managing transactions, or performing replication processes. While the source repositories 122, 122a serve as the master repository for schema and procedure updates, cluster application repositories 123, 123a and tenant repositories 124, 124b store the versions appropriate to their operation, so that each component has access to the required versioned data without direct access to the main repository at runtime.

As part of the update process, schema changes and stored procedure updates associated with an application or feature update are managed to facilitate the transition between different software versions. During the update of the system cluster applications 132 and tenants 148, the configuration repository 122a stores information needed to generate the updated schema and stored procedure definitions. Cluster application repositories 123 and 123a function independently, with 123a receiving the latest configuration data from 122a, while tenant repositories 124 and 124a maintain both blue (pre-update) and green (post-update) versions of schema and stored procedure data to support backward compatibility during transitions.

When transitioning to an updated tenant repository version 124a, the update service 118 deploys the stored procedures, table definitions, and other configuration data from the cluster application repository 123a to the tenant repository 124a. This structure allows the task manager 138a to access 124a and continue executing blue-version tasks for tenants 148 until all related components, including 162, have been updated to green. By retaining blue-version compatibility within 124a, this update process ensures that tenants 148 have access to the appropriate schema and stored procedure versions until fully updated to green, thereby preventing disruptions by aligning stored procedures and schemas with each tenant's software state.

Similarly, stored procedures 129 may be updated (to 129a) to reflect new logic or processes introduced in the green version, while older procedures from repository 122 remain accessible within repository 122a for the blue version. For a transition period, repository 122a stores both new configuration and feature information alongside the legacy data from repository 122. These stored procedures support tenant-specific operations, such as replication tasks or data queries, and remain available in both blue and green versions to allow tenant operations to continue during the update process. By retaining both blue and green versions of schemas and stored procedures 129, 129a in the configuration repository 122a, the system allows tasks initiated by tenants on older software to be processed correctly, while tenants on the green version can use updated schemas and procedures. This dual-version storage facilitates continuous operations and minimizes disruptions, enabling tenants 148 to function based on their respective version states.

The tenant configurations 128, 128a allow each tenant's progress through the update process to be tracked, feature availability adjusted accordingly. This facilitates staged updates, allowing tenants to transition to new software versions at their own pace without requiring a system-wide update for all tenants simultaneously, which may require the entire computing cluster 110 to be taken offline.

Storing the tenant configuration 128 in a structured format, such as a relational database table, updates to tenant and feature setting to be made using via standard SQL (Structured Query Language) commands. For example, when a tenant is updated, a SQL UPDATE command can change a feature name from “feature_1_inactive” to “feature_1”, thereby activating the feature for the tenant, provided that the feature has been toggled on. Similarly, features can be toggled on or off across tenants using SQL queries, providing a fast and reliable way to handle feature rollouts without requiring manual intervention or complex reconfiguration.

The computing cluster 110 incudes system cluster applications 132, which can serve as application instances that can service multiple tenants 148 in the computing cluster. The system cluster applications 132 can include functionality to manage operations such as task execution, configuration management, and overall system operation across different versions of the application.

In the specific example shown, the system cluster applications 132 include a configuration manager 136, a task manager 138, and a task executor framework 140. In a particular example, the system cluster applications 136, 138, 140 can facilitate data replication from the computing cluster 110 to another computing system, just as a target repository 154 of a target system 152.

The configuration manager 136 manages the system-wide settings and configurations for the application components of the cluster applications in the computing cluster 110. The configuration manager 136 is responsible for configuring one or more cluster applications 132 properly for a current state, including states where tenants 148 may be running different versions of components that interact with the cluster applications 132.

The task manager 138 handles the coordination and scheduling of tasks throughout the computing cluster 110. In a specific example, the task manager 138 can be the RMS software, which manages data replication tasks for tenants 148 in the computing cluster 110, each of which may be running different versions of the software. In this implementation, the configuration manager 136 can be the Cluster Configuration Manager (CCM) as implemented in technologies of SAP SE, of Walldorf, Germany. The task manager 138 coordinates with the task executor framework 140 to distribute and monitor tasks, such as specific replication operations. The task manager 138 can assigned to the appropriate nodes, and handle queuing, prioritization, and status tracking.

The task executor framework 140 causes tasks to be executed across the computing cluster 110, interacting with worker nodes, associated with tenants 148, to ensure that tasks are carried out according to the schedule and configuration set by the task manager 138. The task execution framework 140 can abstract execution details, managing high-level task flows and making sure the underlying task operations are handled seamlessly.

When the task manager 138 is the RMS (Replication Management Service), the task executor framework 140 (which can correspond to the vFlow component of systems of SAP SE, of Walldorf, Germany) is responsible for executing replication tasks that synchronize data between a source system and a target environment, such as between the computing cluster 110 and a target repository 154 of a target system 152.

The task manager 138 coordinates these replication tasks, distributing them appropriately across the system to an appropriate tenant 148, in a format appropriate to the code version running on a given tenant. The configuration manager 136 in the context of RMS handles the settings and configurations necessary for executing replication tasks. In some implementations, it can provide that features are called at a tenant 148 only if the code running on the tenant supports the feature, which, as described, can be affected both by the state of a feature flag 126 and a feature name for the tenant maintained in the tenant configuration 124 compared with a feature name 126a. In some cases, the configuration manager 136 or another component is responsible for controlling the name of the feature used by tenants 148, facilitating the renaming process. After a tenant repository 124 has been upgraded to 124a, the task manager 138a accesses the updated tenant repository for definitions, including updated tables and stored procedure definitions, which in turn were provided to the updated tenant repository from the updated cluster application repository 123a.

The update service 118 can initiate an update process for the system cluster applications 132. Upon detecting the availability of a new software version, the update service 118 coordinates with the configuration manager 136, task manager 138, and task executor framework 140 to manage the version transition.

In an RMS update scenario, the system update service 118 instructs the configuration manager 136 to apply the necessary configuration updates for the new RMS version. The task manager 138 allows in-progress replication tasks to continue uninterrupted, such as using settings in the tenant configuration 128 for the cluster application version that is being updated, while the task executor framework 140 oversees their execution, including that data is not lost during the transition. Once the update is applied, new replication tasks use updated tenant configurations 128a and feature flags 126a.

In scenarios where a tenant 148 has issued work orders (tasks) before an update (referred to as “blue” work orders), disclosed techniques allow these tasks to be completed even after the system cluster applications 132 have been updated. The task manager 138a coordinates the execution of these work orders, while the router 166 posts work order responses for blue work orders back to the system cluster applications 132a or external clients for further processing. The post-blue work order responses can include task execution outcomes, such as success or failure, or may include data processed as part of the task, which can then be transmitted to a target system, such as a database or object store. The router 166 facilitates the completion of these tasks, initiated under an older system state, according to the blue version's APIs and schemas, as reflected in repository 122 a (which stores both blue and green version data), while new tasks use the green version's updates and the updated repository 122a information. This dual-version handling allows operations to continue during the transition period, enabling tasks under both blue and green versions to coexist and complete without disruption.

Tenants 148 in the computing cluster 110 can represent individual customer environments, each operating with its own task execution logic and configuration. Each tenant 148 contains its own task executor framework 160, which manages and executes tasks specific to that tenant, received via the task execution framework 140, allowing isolated task execution per tenant. This implementation allows for each tenant's operations to proceed independently, even if other tenants are running different application versions or undergoing updates. The task executor framework 160 performs similar operations as the task executor framework 140 in managing task flow, but during execution at a particular tenant 148

The tenants 148 also include task executors 162, which are primarily responsible for the actual execution of tasks. While the task executor framework 160 orchestrates the overall task flow, managing dependencies and transitions, the task executor 162 focuses on the operational-level execution of tasks, such as running data queries or processing replication tasks according to a replication request for the specific tenant 148.

To manage communication and request routing both between external clients of a tenant 148 and within the broader computing cluster 110, the computing cluster includes a router 166. The router 166 routes requests initiated by external clients, such as replication processes, system updates, or data management tasks, to the correct tenant 148, allowing them to be executed according to the tenant's current code version and configuration. For example, if a tenant 148 is using an older version of tenant-side components of RMS, the router 166 directs the request to be processed using the appropriate configuration and APIs for that version. Additionally, within the cluster, the router 166 manages the posting of work order responses, such as outcomes or processed data from blue work orders, back to the system cluster applications 132a or to external clients. This approach allows operations to continue across different software versions during transitions, with tasks being handled according to the tenant's software state.

In addition to routing API requests to the correct application instance, the system can use version-specific port names to manage communication between old (blue) and new (green) versions. When a tenant 148 is running an older version of the software, external client requests and system tasks are routed by the router 166 to ports corresponding to the APIs of the blue version, allowing requests to be processed using the appropriate configuration and codebase. Conversely, when a tenant 148 has been updated to the green version, the router 166 of the updated environment directs requests through ports associated with the updated APIs of the green version. This separation of ports allows for simultaneous operation of multiple software versions, maintaining compatibility for tasks initiated under the blue version while enabling the use of new features in the green version. By managing distinct ports for different versions, the router 166 supports tenant updates and transitions without interrupting ongoing tasks or causing conflicts between versions.

In addition to handling communication and task routing, the router 166 (and the router 166) is also responsible for directing client requests to the appropriate application instance APIs based on the tenant's software version. When an external client submits a request, the router 166 determines which version of the application instance API is compatible with the tenant's current software and routes the request accordingly. This allows clients interacting with tenants operating different versions of the software to receive the correct response, whether through blue version APIs for tenants 148 on older software or green version APIs for tenants that have been updated.

As described, a feature toggle is employed during system updates to decouple feature activation from the software update process. This toggle mechanism allows new features to be activated once they are ready without requiring all tenants to be on the latest version and without having to update full code of the cluster applications 132. When the update service 116 initiates an update for the computing cluster 110, it includes the delivery of a complete feature implementation, which may remain inactive for tenants still running an older version of the system.

Computing cluster 110a represents the computing cluster 110 after an update of a cluster application 132, which can include the deployment of a feature implementation or a full update of the cluster application. Components of the cluster 110a that share reference numbers with the original cluster 110, such as the configuration manager 136, indicate no change in functionality. Cluster application repository 123a and tenant repository 124a contain only the configuration, schema, and stored procedures specific to each tenant's current state, either blue or green, as aligned with their respective versions. Components with an “a” appended to the reference number (e.g., task manager 138a) represent changes in functionality or updated logic that manage whether operations for tenants 148 are performed using the updated feature and configuration information.

Backward compatibility is maintained by storing both blue (older) and green (newer) versions of schemas, configurations, and feature flags in each relevant repository (123a, 124a) according to each tenant's update status. The update service 116 can use version-specific identifiers that align with updated tenant configurations, so that green tenants receive “active” feature names, while blue tenants retain prior identifiers. This approach avoids disruptions, allowing blue tenants to access their existing configurations independently until they transition to the green version.

Once a tenant 148 has its code updated to the newer version, a feature activation process occurs through the deployment of new content that omits the identifier's prior inactive designation (e.g., changing from “feature_1_inactive” to simply “feature_1” in the deployed content). This deployment can be handled by the configuration manager 136 or the update service 118, so that non-updated tenants do not inadvertently activate the new features.

In the implementation where a recently activate feature is a feature of RMS, the feature toggling and renaming mechanisms allow the system to handle complex replication tasks and manage new feature activations related to replication workflows. Even while the updated task executor framework 140a handles new replication tasks, tenants 148 still running the older version continue to use the previous feature set, thus allowing tenants to take advantage of new feature as soon as they are updated, but without requiring tenants with older code to be taken offline.

The router 166 manages task routing, including results of task execution, for tenants 148 still operating on the blue version and those updated to the green version. The task executor framework 140a processes new green worker tasks using updated features while maintaining compatibility with the blue worker tasks. The task executor framework 140 coordinates the completion of tasks initiated under the blue version using the corresponding APIs and task configurations. Once a tenant 148 is updated, green worker tasks are used for new replication operations, while blue tasks continue to be handled for outstanding operations. This dual-task handling during version transitions allows for both blue and green tasks to be executed during the update process without interruption.

During the update process, configuration, schema, and feature flag data from the configuration repository 122a is propagated to the cluster application repository 123a and tenant repository 124a. These updated repositories support independent runtime operations, containing the version-specific settings, schema, and procedures necessary for cluster applications 132a and tenants 148a, respectively. The update service 118 manages the distribution of this data to ensure green tenants can utilize updated feature configurations and schemas, while blue tenants continue to access settings aligned with their current version, but from the updated repository 124a. Feature identifiers are directly deployed in their active form for updated tenants, enabling content deployment with the final identifier.

### Example—Example Feature Toggling and Feature Renaming Operations

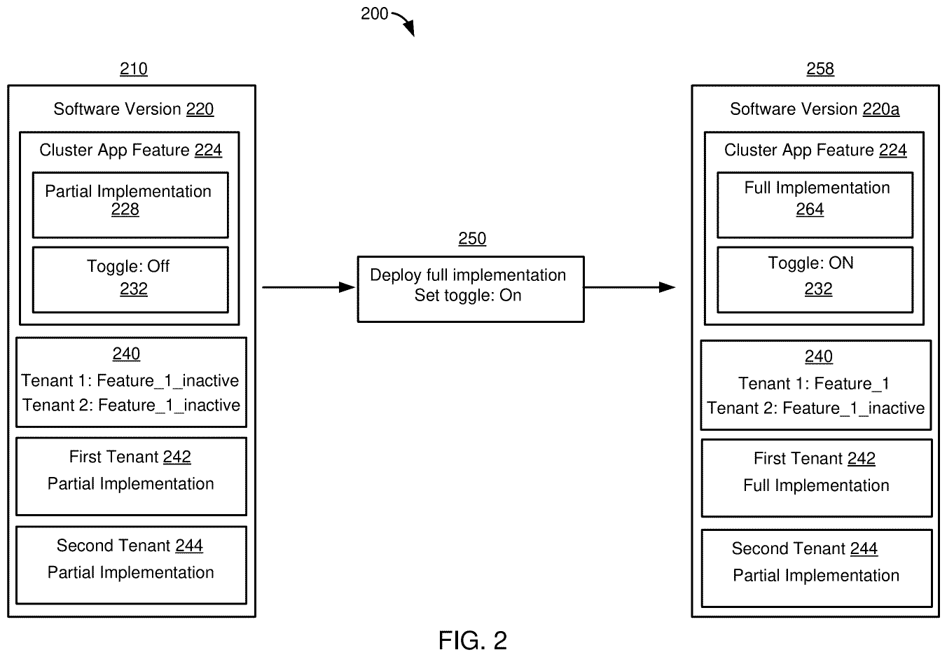

FIG. 2 provides a diagram of a computing environment 200 that illustrates operations and cluster states before and after a software update. At a first time 210, a first software version 220 includes a feature 224 that has a partial implementation 228. The partial implementation 228 allows developers to test portions of the feature 224 or assist in other development efforts. Since the partial implementation 228 is not intended for use by end users, the feature 224 is associated with a cluster-wide toggle state indicator 232, which is set to OFF. Because the toggle is off, the feature 224 will not be used by any tenants of a computing cluster (such as tenants 242, 244 in FIG. 2).

To further provide that the feature 224 is not activated for tenants, even if the toggle state indicator 232 is later set to ON, each tenant can be associated with a specific version-specific identifier for the feature 224. Programmatic logic checks for this identifier before executing the feature. A repository 240 stores these feature identifiers for each tenant, allowing for tenant-specific control. As shown, the repository 240 includes entries for a first tenant 242 and a second tenant 244. The actual identifier of the feature 224 is “Feature_1,” but the entries in the repository 240 initially reflect “Feature_1_Inactive” for both tenants. Because the identifiers stored in the entries differ from the actual identifier, the feature 224 will not be executed for either tenant 242, 244, regardless of the state of the toggle.

At 250, as part of an update process, a full implementation of the feature 224 is deployed. This is shown in software version 220a at a second time 258 as a full implementation 264, which occurs after the first time 210. Operations at 250 also include setting the toggle state indicator 232 to an ON state, as depicted at the second time 258.

Even when the toggle is set to ON, the full implementation 264 of the feature 224 will not be executed unless the identifier for a tenant 242, 244 matches the expected identifier “Feature_1.” At the time 258, the entry for the first tenant 242 has been updated to this identifier, indicating compatibility with the full implementation of the feature 224. At this point, the feature is available to the first tenant's operations. However, the entry for the second tenant 244 still reflects the “_Inactive” suffix, meaning the feature remains inactive for this tenant. Once the second tenant has been successfully updated, the entry in the repository 240 will be adjusted to the expected identifier, thereby making the feature 224 accessible for the second tenant's operations as well.

### Example 4—Example Tenant Feature and Software Version Information

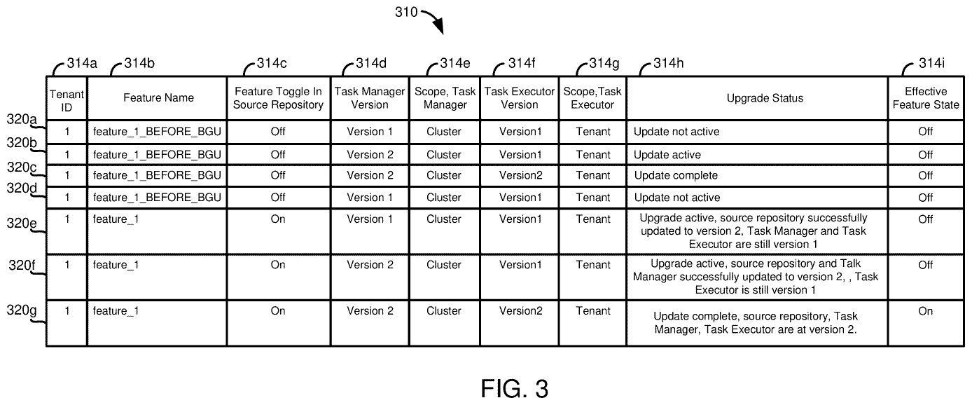

FIG. 3 provides a table 310 illustrating the sequential stages of an update process for a single tenant (Tenant 1) within a distributed computing environment, detailing the progressive activation of a software feature and the update of critical software components. The table includes columns for Tenant ID 314a, Feature Name 314b, Software Feature Toggle 314c (reflecting the toggle state in the configuration repository), Task Manager Version 314d, Task Manager Scope 314e, Task Executor Version 314f, Task Executor Scope 314g, Upgrade Status 314 h, and Effective Feature Toggle 314 i. Each row represents a specific state during the update, detailing Tenant 1's progression from the initial deployment of a partial feature implementation through full activation after all components are updated.

Row 320a represents the initial deployment state for Tenant 1 with a partial implementation of a new feature, where no update has been initiated for Tenant 1. Here, the Feature Name column 314b shows “feature_1_BEFORE_BGU,” a placeholder identifier indicating that the feature's partial implementation should not be executed. The Software Feature Toggle 314c in the configuration repository is set to “Off,” preventing feature activation. Both the Task Manager Version 314d and the Task Executor Version 314f are at Version 1, with the Task Manager operating at the “cluster” scope and the Task Executor at the “tenant” scope. In this state, the Upgrade Status column 314h is labeled as “Upgrade Not Active,” reflecting that no update has been initiated. Consequently, the Effective Feature Toggle 314i remains “Off.”

Row 320b shows the next stage, where the Task Manager for Tenant 1 has been upgraded to Version 2 while the Task Executor remains at Version 1. The Feature Name 314b remains “feature_1_BEFORE_BGU,” with the Software Feature Toggle 314c still set to “Off.” The updated Task Manager Version 314d to Version 2 signals the beginning of the update process, allowing the cluster to prepare for feature activation once all components are updated. The Upgrade Status column 314h now indicates “Upgrade Active,” although the feature is not yet active, as reflected by the “Off” state in Effective Feature Toggle 314i.

Row 320c illustrates the completion of the Task Manager and Task Executor updates to Version 2. Here, both the Task Manager Version 314d and Task Executor Version 314f are set to Version 2, and their respective scopes remain “cluster” and “tenant.” The Feature Name 314b still shows “feature_1_BEFORE_BGU,” and the Software Feature Toggle 314c remains “Off,” ensuring the feature is inactive until all quality and compatibility checks are complete. The Upgrade Status column 314h is marked as “Upgrade Completed,” indicating the update process for Tenant 1 is finalizing. The Effective Feature Toggle 314i is still “Off,” preventing feature execution.

Row 320d represents the state where the feature has been certified for release in Version 2 by a quality team, and a developer updates the feature name to “feature_1.” Here, the Feature Name 314b is now “feature_1,” and the Software Feature Toggle 314c in the configuration repository is set to “On,” making the feature available for activation once the tenant reaches the required configuration. The Task Manager Version 314d and Task Executor Version 314f are both still at Version 1, as Tenant 1 has not yet begun the version upgrade process. The Upgrade Status 314h remains “Upgrade Not Active,” and the Effective Feature Toggle 314i remains “Off,” as the tenant is still operating in the pre-update state.

Row 320e illustrates the scenario where the configuration repository has been successfully upgraded to Version 2, while the Task Manager and Task Executor remain at Version 1. The Feature Name 314b is still “feature_1,” and the Software Feature Toggle 314c is set to “On,” allowing the feature to be accessible in the updated environment. However, since both the Task Manager Version 314d and Task Executor Version 314f are at Version 1, the Upgrade Status column 314h shows “Upgrade Active,” and the feature remains inactive in the Effective Feature Toggle 314i.

Row 320f reflects the next stage, where the Task Manager has been updated to Version 2, aligning with the configuration repository version, while the Task Executor remains at Version 1. In this configuration, the Feature Name 314b remains “feature_1,” and the Software Feature Toggle 314c stays “On.” Although the Task Manager is now compatible with the updated feature, the Task Executor Version 314f at Version 1 prevents the feature from activating fully for Tenant 1. The Upgrade Status column 314h shows “Upgrade Active,” and the Effective Feature Toggle 314i is still “Off,” ensuring the feature remains inactive until all components are fully compatible.

Row 320g shows the final state for Tenant 1 after both the Task Manager and Task Executor are upgraded to Version 2, with all components aligned for full feature activation. The Feature Name 314b remains as “feature_1,” and the Software Feature Toggle 314c is “On,” allowing the feature to be active in this fully updated environment. With both the Task Manager Version 314d and Task Executor Version 314f at Version 2 and the upgrade process completed, as indicated by “Upgrade Completed” in the Upgrade Status column 314h, the Effective Feature Toggle 314i is set to “On.” This final state marks the full activation of the feature for Tenant 1, with all prerequisite upgrades in place.

This staged update process provides granular control over feature activation, so that Tenant 1 can only access the new feature after each component of the environment has been verified and updated to the necessary version. By coordinating the update of cluster-level and tenant-specific components and employing version-specific identifiers and toggles, the system prevents premature feature access while enabling independent, uninterrupted updates across tenants within the cluster environment.

### Example 5—Example Task Request Routing During Software Update

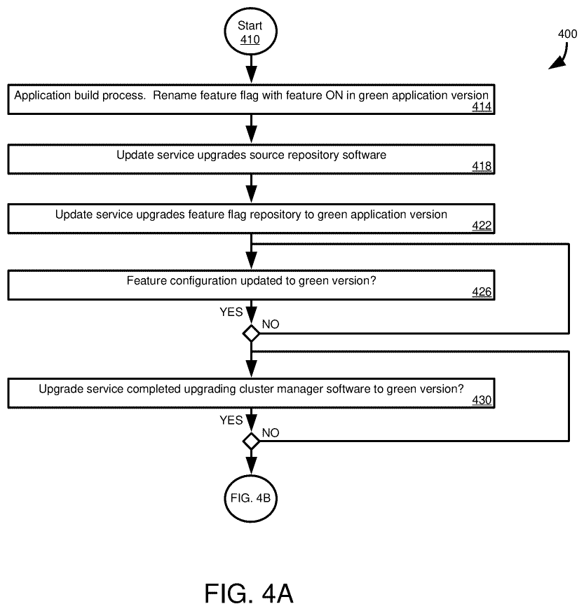

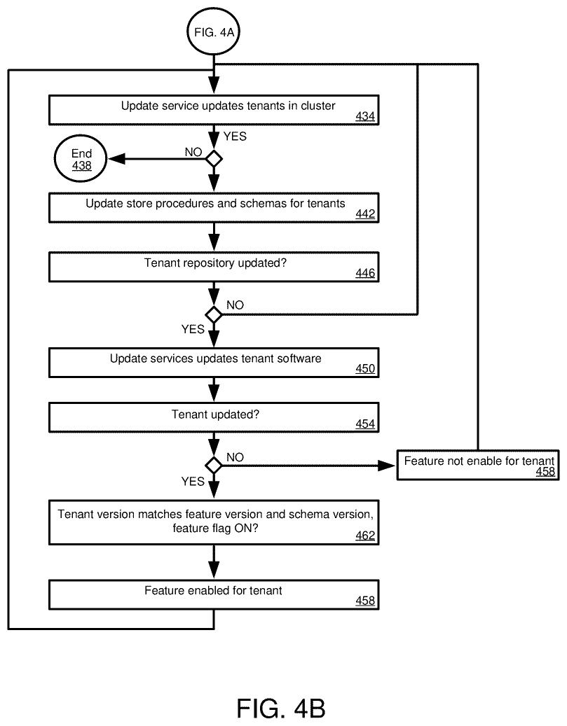

FIGS. 4A and 4B present a flowchart detailing a process 400 for handling task requests and managing feature activation during a software update. The process 400 enables tenants in a distributed computing environment to operate continuously, with tasks and features remaining compatible with each tenant's specific software version throughout a phased update sequence.

At the start of process 400, as shown in FIG. 4A, an application build process begins at 410. At 414, a new version of the application is prepared, specifically updating the feature flag to “ON” for the green (updated) application version. This configuration step enables the updated application to recognize and potentially activate new or enhanced features.

The update service initiates an upgrade to the configuration repository software to support green application versions at 418. This operation involves synchronizing the configuration repository with the new green configurations, preparing it to handle requests and configurations that align with the updated application build. The configuration repository manages configurations, feature flags, and other settings for various tenant and cluster applications, such that the green version settings are applied appropriately.

At 422, the update service upgrades the feature flag repository to the green version. This repository upgrade enables tenants and the cluster application to access the latest feature flags set to “ON” for the green version. By synchronizing these settings, the system prepares to apply the new feature configurations only for tenants compatible with the green version while maintaining backward compatibility for other tenants.

It is determined at 426 if the feature configuration in the configuration repository has been updated to the green version. If the configuration update is incomplete, the process 400 loops back to 426, indicating that further updates are needed. This ensures that all components in the configuration repository match the green version specifications before moving forward.

If it is determined at 426 that the feature configuration update is confirmed, the process proceeds to 430, where it is determined whether the update service has completed the upgrade of the cluster manager software to the green version. Success completion results in the cluster manager being compatible with the updated feature flags and configurations in the green version, allowing it to manage tasks and operations based on the new settings. If the upgrade has not been completed, the process 400 loops at 430. Otherwise, the process 400 proceeds to 434, in FIG. 4B, where tenant-specific updates begin.

At this stage, the update service starts updating tenant-specific components in the cluster, including the tenant repository and any tenant-specific task executors. This staged approach allows each tenant to gradually adopt the green version while continuing operations under the blue (original) version as necessary. At 434, it is determined whether the tenant repository has been updated. If so, the process 400 ends at 438. If the update is still in progress, the process 400 proceeds to 442, where stored procedures and schemas are updated for a previously non-updated tenant (which can include a tenant where an update was previously attempted, but failed).

At 446, it is determined whether the update at 442 completed successfully. If not, the process loops to 434 (or can loop at 442, continuing attempts to update a particular tenant. If the update at 442 was successful, tenant software components, including the tenant's task executor framework, are updated to the green version at 450. This final tenant allows the tenant-specific applications and task executors to with the green version of the cluster manager and configuration repository, fully enabling green-compatible operations.

At 454, it is determined whether the tenant software update is complete, including the version of the tenant software matches a version specified for feature enablement, and whether the schemas and stored procedures. If not, the feature is not enabled, as indicated at 458, and the process 400 can return to 434, or a latter step associated with a specific failure point, such as 442. Thus, tenant operations are only transitioned to the green environment once the tenant-specific task executors and configurations are fully compatible.

At 462 it is determined that the tenant software (including feature) version and schemas and stored procedures are at the specified version, and that the feature was toggled to ON. At this point, the tenant communicates with the green version of the cluster applications. The feature is then activated for the tenant at 466, and the process 400 returns to 434.

### Example 7—Example Update Operations

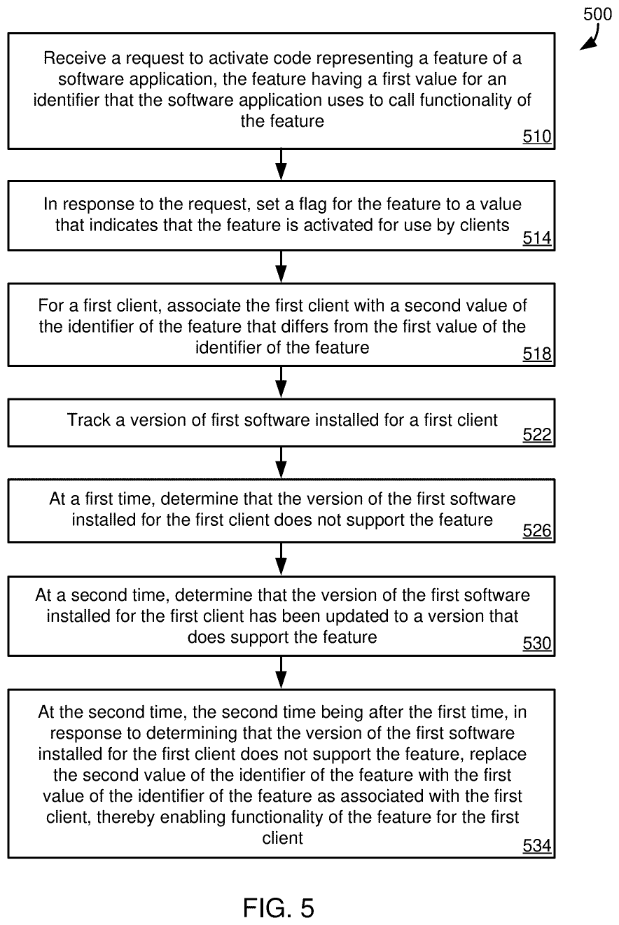

FIG. 5 is a flowchart of a process 500 of activating a feature for use by a client. At 510, a request to activate code representing a feature of a software application is received, the feature having a first value for an identifier that the software application uses to call functionality of the feature. In response to the request, at 514, a flag for the feature is set to a value that indicates that the feature is activated for use by clients.

For a first client, the first client is associated with a second value of the identifier of the feature that differs from the first value of the identifier of the feature at 518. At 522, a version of first software installed for the first client is tracked. It is determined at 526 that the version of the first software installed for the first client does not support the feature. At 530, at a second time, it is determined that the version of the first software installed for the first client has been updated to a version that does support the feature. At 534, at the second time which is after the first time, in response to determining that the version of the first software installed for the first client does not support the feature, the second value of the identifier of the feature is replaced with the first value of the identifier of the feature as associated with the first client, thereby enabling functionality of the feature for the first client.

### Example 8—Additional Examples

Example 1 is a computing system that includes at least one hardware processor, at least one memory coupled to the at least one hardware processor, and one or more computer-readable storage media. The storage media store computer-executable instructions that, when executed, cause the computing system to perform operations. The operations include receiving a request to activate code representing a feature of a software application, the feature having a first value for an identifier that the software application uses to call functionality of the feature. In response to the request, a flag for the feature is set to a value that indicates that the feature is activated for use by clients.

For a first client, the first client is associated with a second value of the identifier of the feature that differs from the first value of the identifier of the feature. A version of first software installed for the first client is tracked. At a first time, it is determined that the version of the first software installed for the first client does not support the feature. At a second time, it is determined that the version of the first software installed for the first client has been updated to a version that does support the feature. At the second time, the second time being after the first time, in response to determining that the version of the first software installed for the first client does not support the feature, the second value of the identifier of the feature is replaced with the first value of the identifier of the feature as associated with the first client, thereby enabling functionality of the feature for the first client.

Example 2 is the computing system of Example 1, where the operations further include, for a second client different than the first client, associating the second client with a third value of the identifier of the feature that differs from the first value of the identifier of the feature, where the third value is the second value or is another value other than the first value. While the first client has the version of the first software that does not support the feature, it is determined that the second client has been updated to a version of the first software that does support the feature. While the first client has the version of the first software that does not support the feature, the third value is replaced with the first value.

Example 3 is the computing system of Example 1 or Example 2, where the first client and the second clients are tenants in a multitenant computing cluster.

Example 4 is the computing system of Example 2 or Example 3, where the first client and the second client receive tasks from a common application instance.

Example 5 is the computing system of any of Examples 2-4, where the operations further include, during an update of the first client to a version of the first software that supports the feature, deploying updated content to a repository associated with the first client, such that after the deployment, the repository includes content compatible with both the version of the first software that supports the feature and the version that does not support the feature.

Example 6 is the computing system of any of Examples 1-5, where the operations further include, as part of an update of second software that interacts with the first software, modifying a data schema used by the second software while making data from the data schema prior to modification available to the first client while the first client has the version of the first software that does not support the feature.

Example 7 is the computing system of any of Examples 1-6, where the operations further include, as part of an update of second software that interacts with the first software, modifying an application programming interface used by the second software while making a prior version of the application programming interface available to the first client while the first client has the version of the first software that does not support the feature.

Example 8 is the computing system of Example 7, where the operations further include, as part of an update of second software that interacts with the first software, while the first client has the version of the first software that does not support the feature, receiving a first request from a first external client associated with the first client. Based on determining that the first client has the version of the first software that does not support the feature, the first request from the first external client is routed to an application programming interface of the second software prior to an update of the second software.

Example 9 is the computing system of Example 8, where the operations further include, as part of the update of second software that interacts with the first software, after the first client has been updated to the version of the first software that supports the feature, receiving a second request from the first external client. Based on determining that the first client has the version of the first software that does support the feature, the request from the first external client is routed to an application programming interface of the second software after an update of the second software.

Example 10 is a method, implemented in a computing system that includes at least one hardware processor and at least one memory coupled to the at least one hardware processor. The method includes receiving a request to activate code representing a feature of a software application, the feature having a first value for an identifier that the software application uses to call functionality of the feature. In response to the request, a flag for the feature is set to a value that indicates that the feature is activated for use by clients.

For a first client, the first client is associated with a second value of the identifier of the feature that differs from the first value of the identifier of the feature. A version of first software installed for the first client is tracked. At a first time, it is determined that the version of the first software installed for the first client does not support the feature. At a second time, it is determined that the version of the first software installed for the first client has been updated to a version that does support the feature. At the second time, the second time being after the first time, in response to determining that the version of the first software installed for the first client does not support the feature, the second value of the identifier of the feature is replaced with the first value of the identifier of the feature as associated with the first client, thereby enabling functionality of the feature for the first client.

Example 11 is the method of Example 10, further including, for a second client different than the first client, associating the second client with a third value of the identifier of the feature that differs from the first value of the identifier of the feature, where the third value is the second value or is another value other than the first value. While the first client has the version of the first software that does not support the feature, it is determined that the second client has been updated to a version of the first software that does support the feature. While the first client has the version of the first software that does not support the feature, the third value is replaced with the first value.

Example 12 is the method of Example 11, where the first client and the second clients are tenants in a multitenant computing cluster.

Example 13 is the method of Example 11 or Example 12, where the first client and the second client receive tasks from a common application instance.

Example 14 is the method of any of Examples 11-13, further including, during an update of the first client to a version of the first software that supports the feature, deploying updated content to a repository associated with the first client, such that after the deployment, the repository includes content compatible with both the version of the first software that supports the feature and the version that does not support the feature.

Example 15 is the method of any of Examples 10-14, further including, as part of an update of second software that interacts with the first software, modifying an application programming interface used by the second software while making a prior version of the application programming interface available to the first client while the first client has the version of the first software that does not support the feature.

Example 16 is one or more non-transitory computer-readable storage media that include computer-executable instructions that, when executed by a computing system that includes at least one hardware processor and at least one memory coupled to the at least one hardware processor, cause the computing system to perform various operations. The operations include receiving a request to activate code representing a feature of a software application, the feature having a first value for an identifier that the software application uses to call functionality of the feature. In response to the request, a flag for the feature is set to a value that indicates that the feature is activated for use by clients.

For a first client, the first client is associated with a second value of the identifier of the feature that differs from the first value of the identifier of the feature. A version of first software installed for a first client is tracked. At a first time, it is determined that the version of the first software installed for the first client does not support the feature. At a second time, it is determined that the version of the first software installed for the first client has been updated to a version that does support the feature. At the second time, the second time being after the first time, in response to determining that the version of the first software installed for the first client does not support the feature, the second value of the identifier of the feature is replaced with the first value of the identifier of the feature as associated with the first client, thereby enabling functionality of the feature for the first client.

Example 17 is the one or more non-transitory computer-readable storage media of Example 16, where the operations further include, for a second client different than the first client, associating the second client with a third value of the identifier of the feature that differs from the first value of the identifier of the feature, where the third value is the second value or is another value other than the first value. While the first client has the version of the first software that does not support the feature, it is determined that the second client has been updated to a version of the first software that does support the feature. While the first client has the version of the first software that does not support the feature, the third value is replaced with the first value.

Example 18 is the one or more non-transitory computer-readable storage media of Example 17, where the first client and the second clients are tenants in a multitenant computing cluster and receive tasks from a common application instance.

Example 19 is the one or more non-transitory computer-readable storage media of Example 17 or Example 18, where the operations further include, during an update of the first client to a version of the first software that supports the feature, deploying updated content to a repository associated with the first client, such that after the deployment, the repository includes content compatible with both the version of the first software that supports the feature and the version that does not support the feature.

Example 20 is the one or more non-transitory computer-readable storage media of any of Examples 16-19, where the computer-executable instructions further include, as part of an update of second software that interacts with the first software, modifying an application programming interface used by the second software while making a prior version of the application programming interface available to the first client while the first client has the version of the first software that does not support the feature.

### Example 9—Computing Systems

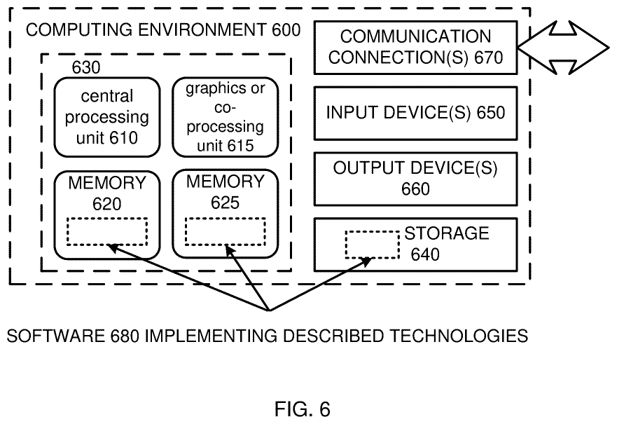

FIG. 6 depicts a generalized example of a suitable computing system 600 in which the described innovations may be implemented. The computing system 600 is not intended to suggest any limitation as to scope of use or functionality of the present disclosure, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, including for implementing techniques described in Examples 1-8. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600. In some cases, the operating system can manage, or assist in managing, query language execution threads or job execution threads.

The tangible storage 640 may be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 620 implementing one or more innovations described herein.

The input device(s) 650 may be a touch input device such as a keyboard, mouse, pen, or trackball, a voice input device, a scanning device, or another device that provides input to the computing system 600. The output device(s) 660 may be a display, printer, speaker, CD-writer, or another device that provides output from the computing system 600.

The communication connection(s) 670 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10—Cloud Computing Environment

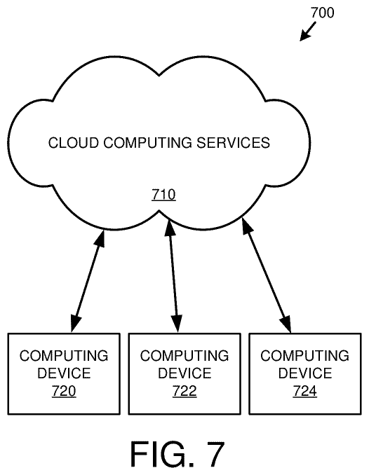

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example 11—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections (e.g., 670).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one hardware processor;
at least one memory coupled to the at least one hardware processor; and
one or more computer-readable storage media comprising computer-executable instructions that, when executed, cause the computing system to perform operations comprising:
receiving a request to activate code representing a feature of a software application, the feature having a first value for an identifier that the software application uses to call functionality of the feature;
in response to the request, setting a flag for the feature to a value that indicates that the feature is activated for use by clients;
for a first client, associating the first client with a second value of the identifier of the feature that differs from the first value of the identifier of the feature;
tracking a version of first software installed for a first client;
at a first time, determining that the version of the first software installed for the first client does not support the feature;
at a second time, determining that the version of the first software installed for the first client has been updated to a version that does support the feature; and
at the second time, the second time being after the first time, in response to determining that the version of the first software installed for the first client does not support the feature, replacing the second value of the identifier of the feature with the first value of the identifier of the feature as associated with the first client, thereby enabling functionality of the feature for the first client.

2. The computing system of claim 1, the operations further comprising:
for a second client different than the first client, associating the second client with a third value of the identifier of the feature that differs from the first value of the identifier of the feature, wherein the third value is the second value or is another value other than the first value;
while the first client has the version of the first software that does not support the feature, determining that the second client has been updated to a version of the first software that does support the feature; and
while the first client has the version of the first software that does not support the feature, replacing the third value with the first value.

3. The computing system of claim 2, wherein the first client and the second clients are tenants in a multitenant computing cluster.

4. The computing system of claim 2, wherein the first client and the second client receive tasks from a common application instance.

5. The computing system of claim 2, wherein the operations further comprise:
during an update of the first client to a version of the first software that supports the feature, deploying updated content to a repository associated with the first client, such that after the deployment, the repository includes content compatible with both the version of the first software that supports the feature and the version that does not support the feature.

6. The computing system of claim 1, the operations further comprising:
as part of an update of second software that interacts with the first software, modifying a data schema used by the second software while making data from the data schema prior to modification available to the first client while the first client has the version of the first software that does not support the feature.

7. The computing system of claim 1, the operations further comprising:
as part of an update of second software that interacts with the first software, modifying an application programming interface used by second software while making a prior version of the application programming interface available to the first client while the first client has the version of the first software that does not support the feature.

8. The computing system of claim 7, the operations further comprising:
as part of an update of second software that interacts with the first software, while the first client has the version of the first software that does not support the feature, receiving a first request from a first external client associated with the first client; and
based on determining that the first client has the version of the first software that does not support the feature, routing the first request from the first external client to an application programming interface of the second software prior to an update of the second software.

9. The computing system of claim 8, the operations further comprising:
as part of the update of second software that interacts with the first software, after the first client has been updated to the version of the first software that supports the feature, receiving a second request from the first external client; and
based on determining that the first client has the version of the first software that does support the feature, routing the request from the first external client to an application programming interface of the second software after an update of the second software.

10. A method, implemented in a computing system comprising at least one hardware processor and at least one memory coupled to the at least one hardware processor, the method comprising:
receiving a request to activate code representing a feature of a software application, the feature having a first value for an identifier that the software application uses to call functionality of the feature;
in response to the request, setting a flag for the feature to a value that indicates that the feature is activated for use by clients;
for a first client, associating the first client with a second value of the identifier of the feature that differs from the first value of the identifier of the feature;
tracking a version of first software installed for a first client;
at a first time, determining that the version of the first software installed for the first client does not support the feature;
at a second time, determining that the version of the first software installed for the first client has been updated to a version that does support the feature; and
at the second time, the second time being after the first time, in response to determining that the version of the first software installed for the first client does not support the feature, replacing the second value of the identifier of the feature with the first value of the identifier of the feature as associated with the first client, thereby enabling functionality of the feature for the first client.

11. The method of claim 10, further comprising:
for a second client different than the first client, associating the second client with a third value of the identifier of the feature that differs from the first value of the identifier of the feature, wherein the third value is the second value or is another value other than the first value;
while the first client has the version of the first software that does not support the feature, determining that the second client has been updated to a version of the first software that does support the feature; and
while the first client has the version of the first software that does not support the feature, replacing the third value with the first value.

12. The method of claim 11, wherein the first client and the second clients are tenants in a multitenant computing cluster.

13. The method of claim 11, wherein the first client and the second client receive tasks from a common application instance.

14. The method of claim 11, furthering comprising:
during an update of the first client to a version of the first software that supports the feature, deploying updated content to a repository associated with the first client, such that after the deployment, the repository includes content compatible with both the version of the first software that supports the feature and the version that does not support the feature.

15. The method of claim 10, further comprising:
as part of an update of second software that interacts with the first software, modifying an application programming interface used by second software while making a prior version of the application programming interface available to the first client while the first client has the version of the first software that does not support the feature.

16. One or more non-transitory computer-readable storage media comprising:
computer-executable instructions that, when executed by a computing system comprising at least one hardware processor and at least one memory coupled to the at least one hardware processor, cause the computing system to receive a request to activate code representing a feature of a software application, the feature having a first value for an identifier that the software application uses to call functionality of the feature;
computer-executable instructions that, when executed by the computing system, cause the computing system to, in response to the request, set a flag for the feature to a value that indicates that the feature is activated for use by clients;
computer-executable instructions that, when executed by the computing system, cause the computing system to, for a first client, associate the first client with a second value of the identifier of the feature that differs from the first value of the identifier of the feature;
computer-executable instructions that, when executed by the computing system, cause the computing system to track a version of first software installed for a first client;
computer-executable instructions that, when executed by the computing system, cause the computing system to, at a first time, determine that the version of the first software installed for the first client does not support the feature;
computer-executable instructions that, when executed by the computing system, cause the computing system to, at a second time, determine that the version of the first software installed for the first client has been updated to a version that does support the feature; and
computer-executable instructions that, when executed by the computing system, cause the computing system to, at the second time, the second time being after the first time, in response to determining that the version of the first software installed for the first client does not support the feature, replace the second value of the identifier of the feature with the first value of the identifier of the feature as associated with the first client, thereby enabling functionality of the feature for the first client.

17. The one or more non-transitory computer-readable storage media of claim 16, further comprising:
computer-executable instructions that, when executed by the computing system, cause the computing system to, for a second client different than the first client, associate the second client with a third value of the identifier of the feature that differs from the first value of the identifier of the feature, wherein the third value is the second value or is another value other than the first value;
computer-executable instructions that, when executed by the computing system, cause the computing system to, while the first client has the version of the first software that does not support the feature, determine that the second client has been updated to a version of the first software that does support the feature; and
computer-executable instructions that, when executed by the computing system, cause the computing system to, while the first client has the version of the first software that does not support the feature, replace the third value with the first value.

18. The one or more non-transitory computer-readable storage media of claim 17, wherein the first client and the second clients are tenants in a multitenant computing cluster and receive tasks from a common application instance.

19. The one or more non-transitory computer-readable storage media of claim 17, furthering comprising:
computer-executable instructions that, when executed by the computing system, cause the computing system to, during an update of the first client to a version of the first software that supports the feature, deploy updated content to a repository associated with the first client, such that after the deployment, the repository includes content compatible with both the version of the first software that supports the feature and the version that does not support the feature.

20. The one or more non-transitory computer-readable storage media of claim 16, further comprising:
computer-executable instructions that, when executed by the computing system, cause the computing system to, as part of an update of second software that interacts with the first software, modify an application programming interface used by second software while making a prior version of the application programming interface available to the first client while the first client has the version of the first software that does not support the feature.
